(19) United States
(12) Patent Application Publication
(10) Pub. No.: US 2012/0135757 A1
(43) Pub. Date: May 31, 2012

(54) METHOD OF SHARING MOBILE SENSOR, APPARATUS FOR VERIFYING INTEGRITY, AND MOBILE SENSOR SHARING SYSTEM

(75) Inventor: Chung Ho LEE, Daejeon (KR)

(73) Assignee: ELECTRONICS AND TELECOMMUNICATIONS RESEARCH INSTITUTE, Daejeon (KR)

(21) Appl. No.: 13/301,143

(22) Filed: Nov. 21, 2011

(30) Foreign Application Priority Data
Nov. 26, 2010 (KR) 10-2010-0118785

(51) Int. Cl. H04W 24/00

(52) U.S. Cl. 455/456.3

(57) ABSTRACT

Provided are a method of sharing mobile sensors, an apparatus for verifying integrity, and a mobile sensor sharing system. The method of sharing mobile sensors includes setting an area-based lattice in a sensor information space including at least one mobile sensor and generating representative virtual sensors representing respective divided lattice spaces, collecting sensor data for each lattice spaces through the representative virtual sensors respectively, and performing primary integrity verification of sensor data newly collected from the sensor information space by checking consistency with peripheral sensor data of a predetermined spatial interpolation area stored in an integrated sensor database.

### CLAIM FOR PRIORITY

This application claims priority to Korean Patent Application No. 2010-0118785 filed on Nov. 26, 2010 in the Korean Intellectual Property Office (KIPO), the entire contents of which are hereby incorporated by reference.

### BACKGROUND

1. Technical Field

Example embodiments of the present invention relate in general to a method of sharing mobile sensors, an apparatus for verifying integrity, and a mobile sensor sharing system whereby sensor information collected by a mobile device such as a smartphone is shared, and more particularly, to a mobile sensor sharing method and system for ensuring data integrity by removing data whose reliability has been degraded due to malfunction of a sensor or intentional influence of a user from collected sensor data.

2. Related Art

A sensor information sharing system provides service in which anyone can participate on a web on the basis of a map to easily register his/her sensor and search for sensor information distributed and shared all over the world as well as his/her sensor information.

Such a sensor information sharing system is gradually being developed to share and integrate information of millions of mobile sensors that have mobility and a communication capability like a smartphone. In particular, with a gradual increase in types and number of sensors that can be mounted on smartphones other than a global positioning system (GPS), a camera, a microphone, and an accelerometer, a project that utilizes such mobile sensor data is being attempted, and a variety of commercial services are expected to emerge. Typical projects are Microsoft's SenseWeb for environment monitoring, CarTel of Massachusetts Institute of Technology (MIT) for traffic monitoring, and so on.

Such a mobile sensor sharing system has a sensor of a general user as a sharing target, and thus data integrity must be maintained to protect data reliability from an error of the sensor itself, incorrect manipulation of a user, and malicious modification of data.

In a conventional access method for ensuring integrity in a mobile sensor sharing system, a hardware device for increasing reliability is installed in each mobile device to upload entire raw data. This conventional technology enables a service provider other than a mobile device owner to ensure sensor data. In this conventional technology, cost for installing additional hardware in millions of mobile devices is necessary, and personal information about a sensor owner is excessively disclosed. Also, upload of entire raw data increases communication cost.

In some mobile sensor sharing systems, a sensor data provider calls a witness for time and a location through surrounding infrastructure at a point in time when uploading sensor data. In this method, infrastructure whose reliability has already been ensured should be extensively installed, and only a data collection location and time other than the corresponding data itself is verified among elements of data integrity.

### SUMMARY

Accordingly, example embodiments of the present invention are provided to substantially obviate one or more problems due to limitations and disadvantages of the related art.

Example embodiments of the present invention provide a method of sharing mobile sensors that ensures data integrity by filtering and removing low-reliability data from collected sensor data without using an additional hardware device or surrounding infrastructure but using a data integrity constraint generation and verification method based on spatial interpolation and a verification method referring to another sensor data provider around a sensor data provider, and a system for sharing mobile sensors using the method.

In some example embodiments, a method of sharing mobile sensors includes: setting an area-based lattice in a sensor information space including at least one mobile sensor, and generating representative virtual sensors representing respective divided lattice spaces; collecting sensor data about the lattice spaces through the representative virtual sensors, respectively; and performing primary integrity verification of sensor data newly collected from the sensor information space by checking consistency with peripheral sensor data of a predetermined spatial interpolation area stored in an integrated sensor database.

The method may further include, when it is determined as a result of the primary integrity verification that the sensor data has no reliability, requesting and receiving sensor data directly from representative virtual sensors in the predetermined spatial interpolation area, and performing secondary integrity verification of the new sensor data on the basis of the received peripheral sensor data.

The method may further include, when the peripheral sensor data of the spatial interpolation area is insufficient to perform the primary integrity verification, expanding the original spatial interpolation area to reset a spatial interpolation area, and iteratively performing the primary integrity verification.

The reset spatial interpolation area may have a radius double that of the original spatial interpolation area.

The method may further include storing the new sensor data whose reliability has been verified through the primary integrity verification or the secondary integrity verification in the integrated sensor database.

The method may further include discarding the new sensor data whose reliability has not been verified through the primary integrity verification and the secondary integrity verification.

In other example embodiments, an apparatus for verifying integrity includes: a sensor manager configured to collect at least one piece of sensor data from a sensor information space divided by an area-based lattice through representative virtual sensors representing respective divided lattice spaces; an integrated sensor database configured to store at least one piece of sensor data whose reliability has been verified; and an integrity verifier configured to perform primary integrity verification of sensor data newly collected from the sensor information space by checking consistency with peripheral sensor data of a predetermined spatial interpolation area stored in the integrated sensor database.

The apparatus may further include a peripheral sensor verifier configured to request and receive sensor data directly from representative virtual sensors in the predetermined spatial interpolation area and perform secondary integrity verification of the new sensor data on the basis of the received peripheral sensor data when it is determined as a result of the primary integrity verification that the sensor data has no reliability.

The integrity verifier may expand the original spatial interpolation area to reset a spatial interpolation area, and perform the primary integrity verification again when the peripheral sensor data of the original spatial interpolation area is insufficient to perform integrity verification.

The reset spatial interpolation area may have a radius double that of the original spatial interpolation area.

The integrity verifier or the peripheral sensor verifier may store the new sensor data whose reliability has been verified in the integrated sensor database.

In other example embodiments, a mobile sensor sharing system collecting sensor data from a sensor information space including at least one sensor data provider and providing sensor information to a sensor information user, the mobile sensor sharing system including: an integrated sensor database configured to store the sensor data obtained from the at least one sensor data provider; and an integrity verifier configured to collect at least one piece of sensor data from a sensor information space divided by an area-based lattice through representative virtual sensors representing respective divided lattice spaces, and perform primary integrity verification of sensor data newly collected from the sensor information space by checking consistency with peripheral sensor data of a predetermined spatial interpolation area stored in the integrated sensor database.

The mobile sensor sharing system may further include: a user manager configured to manage information about at least one user searching for or querying sensor information; and a sensor manager configured to receive the sensor data input from the sensor data provider and store the sensor data in the integrated sensor database.

The sensor data provider may include at least one mobile sensor.

The sensor data may include at least one piece of real-time sensor data and meta-information about the sensor data.

### BRIEF DESCRIPTION OF DRAWINGS

Example embodiments of the present invention will become more apparent by describing in detail example embodiments of the present invention with reference to the accompanying drawings, in which:

FIG. 1 is an overall block diagram of a mobile sensor information sharing system according to an example embodiment of the present invention;

FIG. 2 is a detailed block diagram of an integrity manager in a sensor sharing system based on a virtual sensor according to an example embodiment of the present invention;

FIG. 3 illustrates an interoperation method between a mobile sensor sharing system and a mobile sensor according to an example embodiment of the present invention; and

FIG. 4 is a flowchart illustrating a method of verifying integrity according to an example embodiment of the present invention.

### DESCRIPTION OF EXAMPLE EMBODIMENTS OF THE PRESENT INVENTION

Example embodiments of the present invention are disclosed herein. However, specific structural and functional details disclosed herein are merely representative for purposes of describing example embodiments of the present invention, however, example embodiments of the present invention may be embodied in many alternate forms and should not be construed as limited to example embodiments of the present invention set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention. Like numbers refer to like elements throughout the description of the drawings.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

To ensure integrity of sensor data, example embodiments of the present invention provide a data integrity constraint generation and verification method based on spatial interpolation and a verification method referring to another sensor and provider around a sensor data provider.

To achieve the above-described technological goals, example embodiments of the present invention perform a post-process of verifying and filtering sensor data collected from a mobile device of a sensor sharing system.

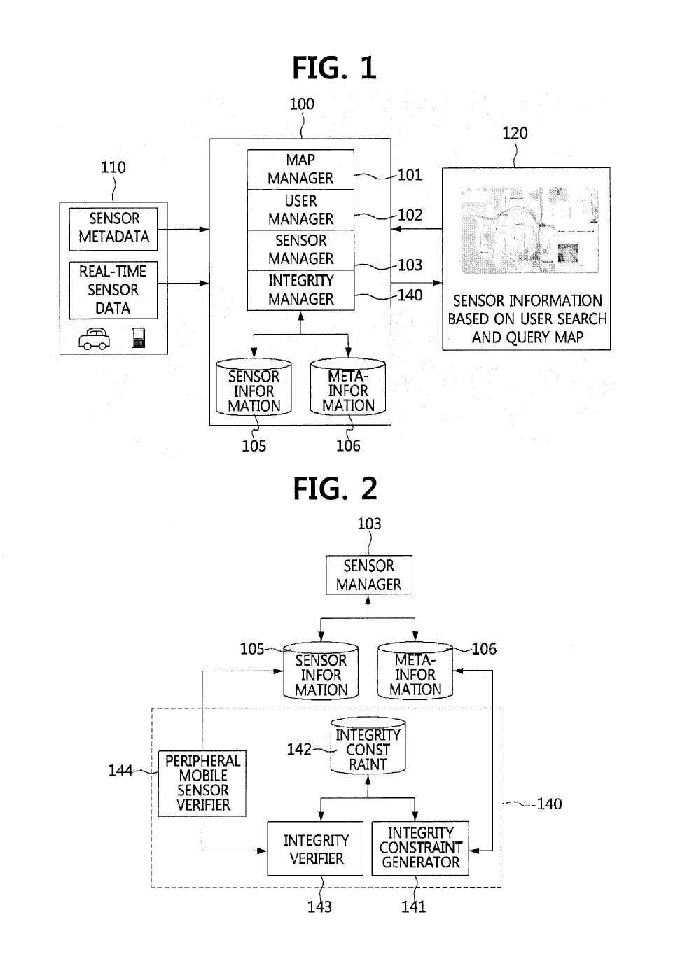

FIG. 1 is an overall block diagram of a mobile sensor information sharing system according to an example embodiment of the present invention.

A mobile sensor information sharing system 100 as shown in FIG. 1 may basically include a map manager 101, a user manager 102, a sensor manager 103, and an integrity manager 140, and provides an access interface (not shown) to a sensor data provider 110 and a sensor information user.

The map manager 101 stores and manages world map information.

The user manager 102 manages information about users who search for or query sensor information under the necessity of sensor information.

The sensor manager 103 receives sensor data input by the sensor data provider 110, and manages information about at least one sensor in a sensor space, such as a dynamic position and a state of connection with each sensor. The sensor manager 103 classifies input sensor data into pure sensor information 105 and meta-information 106 and separately stores the classified sensor data. Here, the meta-information 106 includes information about data relating to a lattice whereby the sensor space according to an example embodiment of the present invention is divided.

The integrity manager 140 serves to perform primary integrity verification and secondary integrity verification of sensor data according to an example embodiment of the present invention.

The mobile sensor information sharing system 100 receives sensor meta-information and real-time sensor data from a sensor data producer as an input, and manages the sensor information 105 and the meta-information 106 in an integrated sensor database. Also, the mobile sensor information sharing system 100 receives a search or query request from a general user 120 as an input, and provides map-based sensor information.

FIG. 2 is a detailed block diagram of an integrity manager in a sensor sharing system based on a virtual sensor according to an example embodiment of the present invention.

In FIG. 2, an integrity constraint 142 denotes a formula for checking consistency with existing data of an adjacent area by spatial interpolation to maintain integrity of newly input sensor data, and is generated by an integrity constraint generator 141. An integrity verifier 143 verifies integrity of the sensor data according to the generated integrity constraint. In the end, the integrity verifier 143 serves to remove data whose reliability has been degraded by malfunction of a sensor or intentional influence of a user from collected sensor data.

A peripheral mobile sensor verifier 144 requests data directly from a mobile sensor around a location where the sensor data detected to have insufficient reliability by the integrity verifier 143 has been collected, and performs comparison and checking. Also, the peripheral mobile sensor verifier 144 may check sensor information 105 and offer an incentive to a mobile sensor user who has provided data in response to the data request.

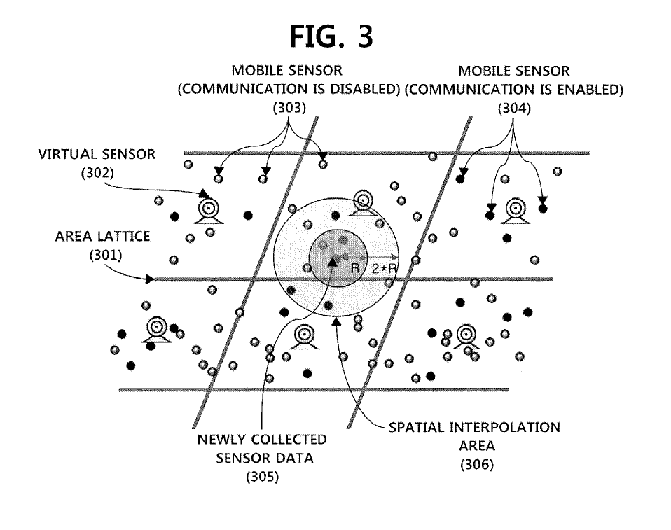

FIG. 3 illustrates an interoperation method between a mobile sensor sharing system and a mobile sensor according to an example embodiment of the present invention.

In FIG. 3, a mobile sensor is mainly installed in a portable terminal of an individual user, and thus is not always connected with a sensor sharing system but is connected with a web or disconnected from a web by interference of the individual user. Thus, mobile sensors may be classified into sensors 303 whose communication is disabled and sensors 304 whose communication is enabled. A sensor information user may receive real-time sensor information through a communication-enabled sensor only.

To solve a problem that the sensor information user needs to check his/her area of interest and a sensor capable of communication and request sensor information according to an example embodiment of the present invention, an area lattice 301 based on a sensor area is set in advance, and virtual sensors 302 representing respective lattice spaces are generated to serve as representatives of a plurality of physical sensors. In other words, the sensor information user may request sensor information about his/her area of interest through a virtual sensor capable of communication and receive a summarized result of the area from the virtual sensor at all times.

At this time, sensor data 305 that has been newly collected from a specific mobile sensor is verified in terms of integrity before being input to a whole data set.

An integrity verification process according to an example embodiment of the present invention may include a primary verification process of setting an area 306 for spatial interpolation and checking consistency with peripheral sensor data, and a secondary verification process performed by requesting sensor data directly from a peripheral mobile sensor through a virtual sensor when it is determined as a result of the primary verification that reliability is insufficient. When the peripheral sensor data is insufficient, the spatial interpolation area 306 is expanded to perform the process again.

As an example, referring to FIG. 3, an original spatial interpolation area is set to have a radius of R. When sensor data of the original spatial interpolation area is insufficient to perform reliability verification, a reset spatial interpolation area has a radius of 2R that is double the original radius.

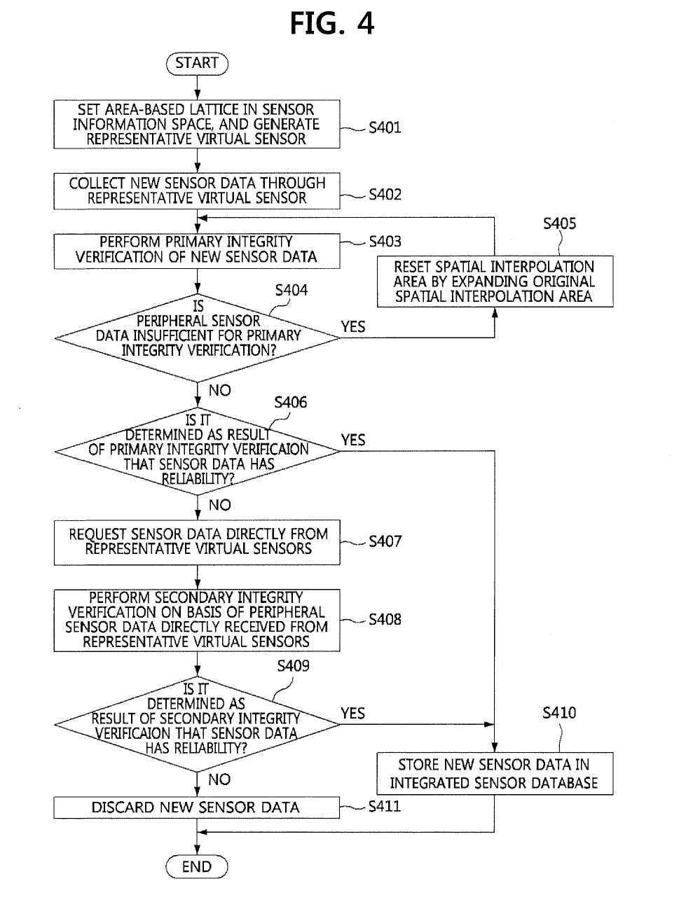

FIG. 4 is a flowchart illustrating a method of verifying integrity according to an example embodiment of the present invention.

An area-based lattice is set in a sensor information space, and representative virtual sensors representing respective divided lattice spaces are generated (S401). Sensor data about the lattice spaces is collected through the representative virtual sensors, respectively (S402). Primary integrity verification of sensor data newly collected from the sensor information space is performed by checking consistency with peripheral sensor data of a predetermined spatial interpolation area stored in an integrated sensor database (S403).

It is determined whether the peripheral sensor data of the predetermined spatial interpolation area is insufficient to perform the primary integrity verification (S404). When it is determined that the peripheral sensor data is insufficient to perform the primary integrity verification, a spatial interpolation area is reset by expanding the original spatial interpolation area (S405), and the primary integrity verification is performed again (S403).

When peripheral sensor data of the current spatial interpolation area is sufficient to perform integrity verification, that is, not insufficient to perform the primary integrity verification (No of S404), it is determined as a result of the primary integrity verification whether reliability of the sensor data is ensured (S406).

When it is determined as a result of the primary integrity verification that the sensor data has no reliability (No of S406), sensor data is directly requested from representative virtual sensors in the set spatial interpolation area (S407), and secondary integrity verification of the new sensor data is performed on the basis of the received peripheral sensor data (S408). As a result of the secondary integrity verification, it is determined whether the sensor data has reliability (S409). When it is determined that the sensor data has reliability (Yes of S409), the sensor data is stored in an integrated sensor database (S410). On the other hand, when it is determined as a result of the secondary integrity verification that the sensor data has no reliability (Yes of S409), the sensor data is discarded (S411).

Unlike conventional art, the example embodiments of the present invention do not involve an additional hardware device for ensuring reliability in a mobile device, thereby enabling more sensor data providers to actively provide their sensor data. The more participating users, the more accurate and extensive information of a sensor sharing system. Thus, it is possible to provide a variety of services with high temporal and spatial resolutions.

Also, huge cost for installing surrounding infrastructure to ensure reliability is reduced, and an incentive to provide sensor data is offered to a peripheral sensor data provider during a process of verifying integrity of sensor data, so that user participation can be doubled.

While the example embodiments of the present invention and their advantages have been described in detail, it should be understood that various changes, substitutions and alterations may be made herein without departing from the scope of the invention.

What is claimed is:

1. A method of sharing mobile sensors, comprising:
setting an area-based lattice in a sensor information space including at least one mobile sensor, and generating representative virtual sensors representing respective divided lattice spaces;
collecting sensor data for each lattice spaces through the representative virtual sensors; and
performing primary integrity verification of sensor data newly collected from the sensor information space by checking consistency with peripheral sensor data of a predetermined spatial interpolation area stored in an integrated sensor database.

2. The method of claim 1, further comprising, when it is determined as a result of the primary integrity verification that the sensor data has no reliability, requesting and receiving sensor data directly from representative virtual sensors in the predetermined spatial interpolation area, and performing secondary integrity verification of the new sensor data on the basis of the received peripheral sensor data.

3. The method of claim 1, further comprising, when the peripheral sensor data of the spatial interpolation area is insufficient to perform the primary integrity verification, expanding the original spatial interpolation area to reset a spatial interpolation area, and iteratively performing the primary integrity verification.

4. The method of claim 3, wherein the reset spatial interpolation area has a radius double that of the original spatial interpolation area.

5. The method of claim 2, further comprising storing the new sensor data whose reliability has been verified through the primary integrity verification or through the secondary integrity verification in the integrated sensor database.

6. The method of claim 2, further comprising discarding the new sensor data whose reliability has not been verified through the primary integrity verification and the secondary integrity verification.

7. An apparatus for verifying integrity, comprising:
a sensor manager configured to collect at least one piece of sensor data from a sensor information space divided by an area-based lattice through representative virtual sensors representing respective divided lattice spaces;
an integrated sensor database configured to store at least one piece of sensor data whose reliability has been verified; and
an integrity verifier configured to perform primary integrity verification of sensor data newly collected from the sensor information space by checking consistency with peripheral sensor data of a predetermined spatial interpolation area stored in the integrated sensor database.

8. The apparatus of claim 7, further comprising a peripheral sensor verifier configured to request and receive sensor data directly from representative virtual sensors in the predetermined spatial interpolation area and perform secondary integrity verification of the new sensor data on the basis of the received peripheral sensor data when it is determined as a result of the primary integrity verification that the sensor data has no reliability.

9. The apparatus of claim 7, wherein the integrity verifier expands the original spatial interpolation area to reset a spatial interpolation area, and iteratively performs the primary integrity verification when the peripheral sensor data of the original spatial interpolation area is insufficient to perform integrity verification.

10. The apparatus of claim 9, wherein the reset spatial interpolation area has a radius double that of the original spatial interpolation area.

11. The apparatus of claim 8, wherein the integrity verifier or the peripheral sensor verifier stores the new sensor data whose reliability has been verified in the integrated sensor database.

12. A mobile sensor sharing system collecting sensor data from a sensor information space including at least one sensor data provider and providing sensor information to a sensor information user, the sensor sharing system comprising:
an integrated sensor database configured to store the sensor data obtained from the at least one sensor data provider; and
an integrity verifier configured to collect at least one piece of sensor data from sensor information spaces divided by an area-based lattice through representative virtual sensors representing respective divided lattice space, and perform primary integrity verification of sensor data newly collected from the sensor information space by checking consistency with peripheral sensor data of a predetermined spatial interpolation area stored in the integrated sensor database.

13. The mobile sensor sharing system of claim 12, further comprising:
a user manager configured to manage information about at least one user searching for or querying sensor information; and
a sensor manager configured to receive the sensor data input from the sensor data provider and store the sensor data in the integrated sensor database.

14. The mobile sensor sharing system of claim 12, wherein the sensor data provider includes at least one mobile sensor.

15. The mobile sensor sharing system of claim 12, wherein the sensor data includes at least one piece of real-time sensor data and meta-information about the sensor data.
